(19) United States
(12) Patent Application Publication
(10) Pub. No.: US 2019/0195540 A1
(43) Pub. Date: Jun. 27, 2019

(54) SOLAR POWERED FREEZER TRUCK

(71) Applicants: Fergus Nolan, Memphis, TN (US); Clyde Edward Bell, Memphis, TN (US)

(72) Inventors: Fergus Nolan, Memphis, TN (US); Clyde Edward Bell, Memphis, TN (US)

(21) Appl. No.: 15/850,552

(22) Filed: Dec. 21, 2017

(51) Int. Cl. F25B 27/00; B60H 1/32

(52) U.S. Cl. CPC F25B 27/005; B60H 1/3232

(57) ABSTRACT

The present disclosure is related to a solar-powered freezer truck. Power for the refrigeration system may be provided by photovoltaic solar cells with battery storage. The refrigeration system may be adapted to run off the Direct Current System Voltage as an efficiency measure to avoid electrical conversion. The powered elements of the refrigeration system, the compressor, defroster, and condenser and evaporator fans may be configured to run on the System Voltage, which may be 24 volts Direct Current.

### BACKGROUND

“Reefer” or refrigerated trucks are used in the distribution of food, medicine, and other temperature-controlled products. A typical ‘reefer’ is an insulated cargo box mounted on a truck. In a typical smaller reefer, the compressor of the refrigeration unit is driven by the truck engine. The truck engine must run or idle constantly to run the refrigeration unit. An AC electrical backup is often provided which typically requires 240 volts AC or three-phase power to operate. This makes the conventional reefer unsuitable for a small operator to run multi-day over-the-road trips, as typical overnight stops do not provide 240 volt power, and security considerations make running the truck motor overnight problematic. Automotive fuels yield less than 20% of their energy for usable motive power. Additionally, the requirement to idle the main truck motor represents a major fuel cost.

A first prototype of a solar powered freezer truck, known as ‘Man the Van’, was built by the inventors. It includes a Ford Econoline van with four 24V solar panels, with a combined rated yield of 1000 watts, mounted to a steel rack on the roof. The solar panels are connected via a solar controller to an array of 24 volt sealed lead acid batteries powering a 2 kilowatt inverter. The inverter converts the 24V DC power from the batteries to AC 120 volts. Two conventional chest freezers are mounted inside the van cargo area and are plugged into the inverter. A 24V charger, running on 120V AC electricity supplies additional power overnight, or when parked unattended, while the freezers are loaded.

While the first prototype has been successful, two potential issues have been noted. First, the conversion of the native 24V DC to 120V AC in the inverter carries a conversion cost, measured at about 23% of the input power. Second, the freezers, being self-contained units, vent warm air into the van body. This venting heats up the van, which is not a problem when traveling on the highway as plenty of airflow is available for cooling. When parked at night, however, even with additional ventilation provided by fans, it exerts a penalty of between 20% and 35% of available energy during summer months. As the energy penalties are cumulative, over 50% of the solar energy is lost. The cumulative effect is that the first prototype has thus far been unable to operate 24 hours per day on solar power alone. The first prototype consistently uses less than two units of additional main line power supply energy per day, less than 20% of the energy consumed by the system. This first prototype been very successful and has saved thousands of gallons of fuel when compared to the conventional reefer.

### BRIEF SUMMARY

The current disclosure is designed to address these limitations noted for the first prototype. Some embodiments of the present disclosure may allow for a larger, walk-in freezer.

The success of the proof-of-concept first prototype is dependent on the solar panels above the freezers acting as a solar shield. The inventors have named it the ‘Parasol Effect’. Solar panels are roughly 20% efficient, and, in addition, they waste some of the sun's radiant energy in the form of heat in the panels. Because this heat from the sun does not reach the roof of the vehicle, the freezers below have to work approximately 30% less to maintain frozen conditions.

The current disclosure may include a vehicle mounted freezer unit. The freezer unit may be supplied with power from roof-mounted photovoltaic cells, although the photovoltaic cells may additionally or alternatively be mounted anywhere else on or around the vehicle. A battery array may provide Direct Current at the System Voltage. This System Voltage may be any appropriate voltage, but one embodiment may include a System Voltage of 24 Volts. Some embodiments of the present disclosure may utilize one or more conventional freezer designs, with the main powered components: the compressor, the evaporator and condenser fans, and the defroster unit running on the System Voltage.

As the solar energy available may be marginally sufficient to run the system in certain embodiments, a high premium may be placed on efficiency. Avoiding the energy cost of converting the solar power System Voltage level to Alternating Current or a higher voltage, therefore, may be desired.

### DETAILED DESCRIPTION

The second prototype of the Solar Powered Freezer Truck is named “Van de Soleil” and it may contain three main systems: the power system, the refrigeration system, and the enclosure.

### The Power System

“System Voltage” may be defined as the common DC voltage on which the system operates. In some embodiments, this voltage may be chosen to match the voltage of the main dynamic component of the system: the compressor. The actual voltage of batteries and solar panels are generally higher than the System Voltage. The system voltage of the Van de Soleil prototype is 24V, but it is noted that higher voltage DC compressors and solar panels are becoming available, solar panels and batteries can be connected in series to match many System Voltage levels, and higher System Voltages may be desirable. Generally, relatively high System Voltage allows for reduction of amperage, the thickness of the wires, and energy losses.

The power for the system may be provided by the photovoltaic solar panels. In one embodiment, six Solar World brand photovoltaic solar panels may be utilized. The panels each may output 285 Watts for a System Voltage of 24V, although the panels may generate varying voltages up to 37V. In embodiments including six solar panels, the total output may be about 1710 Watts for a System Voltage of 24V. Any number of solar panels of any brand may be mounted on some or all available horizontal or near horizontal surfaces of the vehicle including the cargo box roof, any crew accommodation and cab roof, the hood, or on support structures projecting outwards up to the legally allowed dimensions for the vehicle type. The solar panels may additionally or alternatively be placed on any other surface or framework connected to the vehicle.

The solar panels, being at System Voltage, may be connected in parallel, although other connection schemes including parallel and series options and combinations thereof may be employed to more closely match the panel voltages to System Voltage.

The solar panel mounts may be created from four 16-feet long aluminum 2-inch L-section rails to match the length of the truck cargo box, although different lengths of cargo box can be accommodated. The rails may be mounted on the roof of the vehicle in a longitudinal orientation with a rail at each of the edges of the cargo area. A concave part of the rail may be facing inwards toward the center of the roof. Two additional rails may be mounted longitudinally near the middle of the roof, with the concavity of each of these additional rails facing the nearest edge of the roof. The distance between each pair of rails may be one-tenth of an inch longer than the width of the solar panels, though another spacing may be chosen. The rails may be attached to a support structure of the truck roof by 3/16^{th} inch stainless steel carriage bolts, lock washers, and nuts. Any other appropriate form of fastener may additionally or alternatively be used. The solar panels may be placed between rails of each pair of rails and may be secured with aluminum pop rivets, although another form of fastener may be used.

One embodiment of the disclosure utilizes 2″ by 2″ aluminum L-sections. Additional or alternative materials or shapes may be used. Any secure form of mounting, including the many proprietary designs of solar panel mounting available on the market or another design of mount, may be used.

At the front of the solar array, a fairing may cover the gap between the front of the solar panels and the roof of the vehicle. Some embodiments may include the fairing made from galvanized sheet metal. Any appropriate material or combination of materials may be used to create the fairing. Airflow under the solar panels may cause the solar panels to detach if the attachment is insufficient. As such, some embodiments include the fairing to reduce the required strength of the fasteners connecting the solar panels to the rails, the rails to the support structure, or any other connection. Some embodiments may include the fairings extending at least partially over the foremost panels nearest the front of the vehicle. The fairings may further extend to the sides of the foremost panels and may be attached to the cargo box and/or a support structure across the front of the panels. The fairing may be made of any suitable non-corroding material including aluminum, alloy, fiberglass, or plastic, and can have a different shape. At least one embodiment may omit the fairing if the panel mounts are strong enough to withstand highway speeds plus headwinds. A combination of bolts, pop rivets, and ultra-high-bond tape may secure the fairing, but the fairing can be mounted using any suitable materials and fasteners.

The 12 gauge pigtail wires of the solar panels may be connected in parallel in two groups of three panels each via 10-gauge wires, which may be conduited to a single point on the roof of the vehicle. The wires may be routed through the roof using a watertight wire gland, although any means of routing and protecting the wiring may be used, and any method of waterproofing the connections and access holes may be utilized. The grouping was chosen to match the solar controllers used, and the wire size was chosen to accommodate the rated wattage of the attached panels. Any suitable grouping and wire size may be used, based on the expected combined amperage of the panels connected to them.

An area for the system power and control devices may be located at the front of the cargo area, into which the solar panel connecting wires may be routed. The control area can be located anywhere appropriate including in the cab of the truck, in an enclosure attached to the truck, or in an enclosure mounted under the bed of the truck. The term Control Area will refer to the structure used for this purpose.

In some embodiments, the connecting wires from the solar panels may be routed to two Renogy brand 1,000 watt solar controllers in the Control Area, although any brand of solar controller may be used. The function of the solar controllers is to condition the variable voltages from the panels to a suitable voltage for charging a battery array or arrays of the System Voltage. The solar controllers may also prevent over voltage, under voltage, or other conditions which might harm the batteries or the solar panels. Although some embodiments utilize two Solar Controllers, any number which the architecture of the controllers used will support may be deployed. The panels may be connected in parallel or series and parallel to match the capacity of the controller(s). The outputs of the solar controller(s) may be connected in parallel to the battery arrays, which may also be connected in parallel. A different connection scheme may be used to match the panel voltage to the System Voltage.

Optional equipment attached to the solar controllers includes switches to isolate the controllers from the panels for maintenance, and various monitoring and measuring devices.

A solar system requires batteries to cater for times when the sun does not shine and to provide dynamic responsiveness to the system. Any battery technology can be used, including lead-acid, AGM (sealed lead-acid), Lithium Ion, NiMH, or other battery technology. The batteries used may be connected in series in groups to achieve nominal System Voltage, using wiring designed to handle the amperage expected in the system. Each series group of batteries may then be connected in parallel to provide the system capacity required.

The batteries may be mounted anywhere on the truck. Some embodiments include battery mount locations that are as low as possible because of the battery's heavy weight. For embodiments utilizing regular unsealed lead-acid batteries, the batteries may be outside the enclosed areas of the truck because of the possibility of hydrogen being emitted.

Some embodiments of the current disclosure may use two battery banks composed of lead acid batteries. These batteries may be mounted under the truck bed behind protective panels. In a particular embodiment, the left side battery bank may be composed of two 228 Amp Hour 12 volt golf cart batteries, and the right side battery bank may include four 232 AH 6 volt golf cart batteries. Each group may be connected in series using 0-gauge stranded insulated wire, and the pair of 0-gauge terminating wires may be conduited through the vehicle floor into the Control Area. Any combination of batteries may be wired in series to achieve System Voltage, and then in parallel to achieve the required capacity.

Each group of batteries may be housed in mounting under the floor of the cargo area. A cradle may be constructed of welded mild steel, with an expanded metal mesh floor with steel straps and bolts to secure the batteries. Some embodiments may include four vertical tubular supports that may be joined by vertical welded steel tubing and securely attached to the metal members supporting the underside of the truck bed. The battery cradle may have four mounting holes which may align with the vertical support bars. The cradle may freely move vertically while sliding on the support tubes in certain embodiments. In such embodiments, the batteries can be raised and lowered on the support frame, and the cradle is secured in the highest position using clevis pins through the support frame and mounting tubes to keep the cradle in the operational position. These embodiments represent a suitable design for lead-acid batteries under the truck, although any mechanically sound method of mounting the batteries may be used. If the battery chemistry and design is suitable for use in enclosed spaces, e.g. Lithium Ion or Sealed AGM, a simple enclosure or anchoring device anywhere in the vehicle may be used.

At least one embodiment may include a 40 amp 24V battery charger which may be connected to a 110V main electricity supply plug to charge the batteries when the unit is garaged or unattended in a shaded area. The charger may also function as a backup in case the solar charging system or batteries malfunction. The charger may further be used when the operator is sleeping with the vehicle near an available plug and when solar conditions during the day did not allow for sufficient energy generation. It is always possible to imagine weather conditions, such as tropical summer storms, which would make 24/7 solar operation impossible, so the charger may be included, noting that, in one man operation, 120V AC is likely to be available wherever the operator sleeps. The 120 V AC is the standard US main electricity supply, but other voltages are used internationally. A stand-alone generator may also be included for emergencies. Other embodiments may omit the charger. Any other suitable means of providing external charging for the batteries may additionally or alternatively be used.

If ultimate reliability is required for 24/7 operation in multi-person crewed roles, such as ‘Custom Critical’ operations, an additional backup energy source may be provided. An additional alternator rated at the System Voltage may be installed in the truck engine compartment. This additional alternator can be installed on many truck models. Although use of this feature would reduce the fuel efficiency of the system, the impact on overall economy would be relatively small due to the lower percentage of time such a feature would be required. This optional feature does have the effect of increasing the overall reliability of the system to very close to 100%, and embodiments using these redundancies may be more reliable than even conventional available systems.

### The Refrigeration System

In many embodiments, the refrigeration system may run on System Voltage DC, powered directly by the Power System, with no intermediate conversion step. Such a configuration may require modifications to a standard refrigeration system design as found in large commercial fixed and mobile systems. The motive components and auxiliary devices may be replaced with components running at System Voltage.

Some embodiments may include the refrigeration system having a split system, with an Evaporator Assembly mounted inside the freezer enclosure, a Condenser Assembly mounted so that it can vent outside the vehicle, and a Control Assembly mounted in a convenient weather-safe area.

The refrigerant used may be R134a, which may be preferred for environmental reasons and for ease of access, but another refrigerant may be used if appropriate freezer parts are substituted. The system may run at freezer temperatures due to the Ideal Gas Law, which can be used to show that, with constant volume and amount of gas, pressure is proportional to temperature. The system may be run at freezer temperatures, but the system may also be used as a mobile refrigerator. An external refrigerator may be supported by providing and recycling freezer-temperature air from the freezer.

(1) The Condenser Assembly

The Condenser assembly may be mounted under the truck cargo floor, in a cradle mount similar to those described for the battery packs. Other mounting locations and methods may also be contemplated, however. The assembly may be capable of lowering for maintenance using a jack in some embodiments. The refrigerant lines and electrical connections may run through holes in the floor of the Control Area. Although mounting this assembly under the vehicle has been described, it can be mounted anywhere on or in the truck that has access to outside the enclosure to be cooled. The assembly can also be split, with some components outside and others inside the truck. Some embodiments include a low mounting position such that shading or blocking potential sites for solar panels may be minimized, but the condenser components can be placed anywhere which meets the external airflow requirements of the condenser coil.

Some embodiments may utilize a 24V scroll compressor, a model DM24A6-A0218 made by Benling of China. Although this model is discussed, any sufficiently powerful compressor running at the System Voltage could be substituted. R134a refrigerant may be pumped into the compressor via the vacuum line.

The compressor may be bolted to the floor of the enclosure, although any suitable mounting may be used. The compressor may also be supplied with system power via a 0-gauge wire pair running through flexible conduit that routes it to the Control Area, although any gauge of wire appropriate to the amperage of the load may be used. The compressor may be equipped as standard with a control device to switch between the three rotation speeds available. The control switch may be on a short-wire and may be mounted on the back plate of the condenser enclosure, although any suitable mounting position may be chosen.

A refrigerant line may pipe liquid refrigerant from the compressor output to the condenser coil, which may be similar to that used in an air conditioner, although any suitable condenser coil may be used. The condenser coil may be aligned to the outside of the vehicle and may be protected by a mesh screen, although any suitable protection may be used. A cowl may be constructed of sheet metal and placed on the rear of the condenser coil. A fan may then be mounted in the cowl. Any appropriate fan enclosure made of any material may be used. The fan in some embodiments may be a Unimotor model 22055 24V 11 inch device rated at about 100 CFM. Any suitable fan running at System Voltage with sufficient capacity can be used. The fan may be supplied with System Voltage via a pair of 10-gauge wires running through flexible conduit to the Control Area, although any suitable wire gauge for the amperage of the fan can be used.

An optional thermostat may be installed to measure the temperature of the refrigerant liquid and turn off the fan if it is below a safe temperature. In some embodiments, the fan cutoff temperature may be 80 degrees F., although the precise temperature is an implementation decision. An additional starter may be provided in the Control Area when the thermostat is used. The additional starter may function as an efficiency measure to take advantage of temperature and airflow conditions when the fan is not needed.

An accumulator may be installed in the refrigerant vacuum line at the input to the compressor. The accumulator may function to provide a reservoir for surplus refrigerant in response to seasonal changes in refrigerant requirements.

An optional filter may be placed in the liquid line exiting the condenser unit to remove impurities and particles from the refrigerant.

The refrigerant vacuum lines may run through flexible automotive barrier hose, as required by law, with JVC connections to allow for movement of the unit, which may be attached to ⅜ inch copper tubing for the high pressure line, and ⅝ inch copper tubing for the vacuum line, and then to the Control Area, although any suitable refrigerant lines may be used and any appropriate routing to the evaporator may be used.

(2) The Evaporator Assembly

The evaporator assembly may be installed in an aluminum cabinet, which may be mounted in the ceiling of the freezer enclosure on a pair of aluminum rails affixed using screws to the freezer roof frame supports. Any other suitable material and mounting system can be used.

The evaporator coil may be mounted in the rear panel of the cabinet, although it also could be mounted in the front panel. Some embodiments of the evaporator may include an Eagle Refrigeration model VWAL052A, although any suitable model of evaporator could be used. The 110V AC fan installed in the front of the evaporator may be removed and replaced with another Unimotor model 22055 24V 11 inch fan, configured to pull air through the evaporator coil. Although this embodiment has been discussed, another configuration, such as a push design, or another model of fan, could be used.

A custom built defroster may be built into the evaporator coils. In some embodiments, 14 channels are drilled horizontally through the coil body, which is a feature of this model of evaporator. Other embodiments utilizing alternative configurations may also be used. For the embodiment described, however, glass tubing may be placed through these channels and heat wire may be run with a total resistance of just over one ohm back and forth through the channels. The tubes may be sealed and affixed in place in the channels using epoxy or another appropriate fastener. Additional heating wire loops may also be included at the bottom of the coil or any other appropriate location. The heating wires may be bonded to a 10-gauge supply wire pair routed to the control area via flexible conduit, although any appropriate gauge of wire may be used. Any other method of periodically heating the evaporator coil to melt any frost that accumulates on it, which runs at System Voltage, would also work. The heating element should be attached to the coils with enough coverage to melt all ice but with minimal obstruction of the airway through the coil and its fins.

The evaporator may be provided with a drip tray to catch any water from ice melt during the defrost cycle, and a drain may be connected to a pipe which transfers the water through the freezer wall and then down through the control area floor to empty out under the truck. As the water is distillate, this drainage is not an environmental issue. Some other routing for clearing the melt water may be used.

A thermostat or other method of temperature control may be mounted near or in the evaporator to control the cycling of the freezer system, although another method may be used.

The evaporator may be fed by a ⅜ inch copper tube running from the condenser unit through the control area and through the freezer wall. Some other tubing material or routing may be used. This line may terminate in a thermal expansion valve attached to the evaporator coil via a manifold. A standard mechanical bypass expansion valve may be utilized, but any type of mechanical or electronic expansion valve may be used.

The evaporator coil may be attached to a ⅝ inch copper tube which is returned to the compressor via the control area, although some other tubing material and routing may be used.

If an optional thermostat is used to control the compressor cycling, it will be mounted near the evaporator. A thermostat is not required for this purpose in some embodiments, however.

The power supplies to the fan and defroster, any thermostat wiring, the high-pressure liquid line and the vacuum line, and the evaporator drain pipe may be fed through an opening in the side of the freezer enclosure. The opening may be sealed with an appropriate sealant. Some other means of routing these supply lines may be used.

(3) The Freezer Control

The freezer Control Area in the vehicle may be a space between the vehicle cab and the front wall of the freezer. This configuration may allow easy access to all components and connections during initial prototyping and testing, but these components can be placed in any convenient internal or external compartment of the vehicle. In some embodiments, the components may be placed between the condenser and evaporator to reduce cable and refrigerant lines to the minimum length. Minimization of system voltage power supply cable length may also be desirable when configuring the location of the control area.

The control area may served via 0-gauge wire pairs from the battery banks, each of which may be protected by a fuse and provided with a disconnect switch. A suitable wire gauge may be selected based on the amperage of the load.

The system may be controlled initially by the defrost unit. A system run switch may cut off power to the timer device input. A 24 hour quartz-mechanical timer, such as an Intermatic FM1QTUZ-24U, may run on 24V DC, though any suitable timer which runs on System Voltage may be used. The timer may be supplied with power from the batteries to run the clock, which may be unswitched.

When the system run switch is activated, one of the timer relay outputs may be energized. The two output pins on the timer may be for Normally On and Normally Off. If the timer is not currently activated, the Normally On output may be active. This configuration may control the cycling of the compressor. The system may run through a Ranco brand low pressure control, which may be connected via a thin tube to an inspection port on the refrigeration vacuum line. The pressure switch may have an output wire, which runs to the Main Starter. Some other control device, such as a thermostat or other pressure or temperature sensing device may be used.

In some embodiments, the main system starter may be a Fuji model SC-E3/G. Its control input may be connected to the low pressure switch or system thermostat and may be activated when the defrost timer's normally-on output is active. The control input may also be activated when the pressure switch is also active when the system is demanding cooling. The main starter may take power from the battery bank supply and its output wires may be conduited through the floor to power the compressor. Any appropriate routing of the compressor power wires may be used, and any gauge of wire appropriate to the amperage of the compressor.

In some embodiments of the system, the timer switch input is provided by a positive wire from the system switch so the pressure switch and starter control are also positive, and the starter control negative is supplied from the battery bank negative. The negative battery supply can also be used to supply the timer and the other components with the starter positive wire connected to the main power supply positive terminal.

Others forms of starter, relay, solenoid, or other technology can be used as a system starter. Other variations of the wiring scheme may be used.

An additional 10-gauge wire pair may run from the main starter output to the evaporator fan. It may include an optional fuse. Another suitable gauge of wire may be used. This wire pair may run through the freezer wall and power the evaporator fan, which runs whenever the compressor is running. Some other means of controlling the evaporator fan may be used. An additional starter for the evaporator fan, similar to that described below for the condenser fan, may be provided if the evaporator fan is to be run during part of the defrost cycle, or at other times when the compressor is not running.

A second system starter may also be supplied, which runs the condenser fan. The second system starter may be a Fuji model SC-E02G and may be a smaller starter that also runs on system voltage. Any other appropriate starter, relay, solenoid, or other technology can be used as a system starter, or the fans may be started by the main starter.

The function of the condenser fan starter may be to allow a separate circuit for the fan. When the vehicle is moving on the highway, the airflow may often provide sufficient cooling for the evaporator coil, and the fan may not be necessary during very cold ambient conditions. Having a separate circuit for the fan may be an energy conservation measure. This subsystem is optional and the condenser fan may, at an energy cost, be run directly from the main system starter.

The condenser fan starter may be controlled by a thermostat placed at the main high-pressure refrigerant outlet from the condenser unit. The thermostat may be normally on at a temperature above 80 degrees F. A pair of wires may connect the thermostat to a main power terminal and the corresponding polarity of the fan starter. The opposite polarity of the fan starter control may be connected to the corresponding main power terminal. A different threshold temperature may be chosen.

The fan starter may be supplied from the system voltage power supply, and a pair of 10-gauge wires may run from the starter output and be conduited to the condenser fan power inputs. The fan power supply may be fused and may be of any suitable gauge.

The defroster unit may be controlled from the normally off contact of the defrost timer. This device can be set to reverse its outputs when a time event is triggered and to stay activated for a set duration of time. In some embodiments, any combination of fifteen-minute intervals in the 24 hour clock may be set. Any appropriate method of triggering a normally-off output, when defrosts are desired, may be used. It is conceivable that some other means of triggering the defrost cycles may be used, and any method which detects frost build up in the evaporator coils may be used. Many embodiments are set for eight activations per day at regular intervals, but some other schedule may be used.

When the timer normally-off contact is activated, a temperature control device may be energized. Some embodiments of the temperature control device may include a Digiten W1401-24, which is wired to a temperature sensor in the evaporator coil. The components may be connected to system power terminals and the relay input may be connected to the normally-off output from the timer. The temperature control device normally-off output may be routed through a solenoid and its output may be paired with the opposite polarity from the system power terminal and routed via a 10-gauge wire pair to the defroster heater element in the evaporator. Another suitable gauge of wire may be used. Another form of relay, starter or similar device to boost the current capacity, may be used in place of the solenoid, or it may be omitted if a temperature control device equipped with a relay output of sufficient capacity is used.

The function of the temperature control may be to limit the amount of heat supplied to the evaporator coils to the amount required to minimally raise its temperature above freezing. This feature may be omitted at the cost of increased system power consumption, both in the heating and, subsequently, in cooling when the freezer system re-starts.

Any suitable form of temperature controller may be used, and any suitable gauge of power supply wire for the defroster may be implemented. The solenoid may be included if the power draw of the defroster element exceeds the capacity of the temperature controller. If used, any suitable form of relay, starter, solenoid, or other equivalent device may be used.

### The Freezer Enclosure.

In some embodiments, the freezer enclosure may include a rectilinear space measuring seven feet by seven feet in floor area, with a height of approximately five feet nine inches. These dimensions are exemplary and do not limit the disclosure.

The outer skin of the enclosure may include plywood or any other appropriate material. The structure may include 2×4 studs and joists in a standard frame format, although other materials and configurations may be used. The enclosure may also include an inner lining, which may include FRP (Fiber reinforced plastic) panels or another appropriate material. Rubber matting may be located on the floor of the enclosure in some embodiments. The interior of the walls, ceiling, and floor is filled with closed-cell urethane sprayed foam in many embodiments. A sliding door may be provided at the rear of the enclosure with appropriate sealing and a mechanical latch.

Although the above design for the enclosure has been described, any variation of cladding materials, insulation, door mounting, or construction method can be used. The freezer enclosure may have the evaporator assembly mounted to its ceiling, but a wall mounting would also work. A conventional truck-mounted freezer enclosure or any variation thereof may be used.

The freezer may be run at refrigerated temperatures above freezing, or a partition or external compartment may be attached to provide a refrigerated enclosure using conventional technology.

### Van De Soleil Technical Description

Prologue

We built this unit from standard components: 4 Sharp solar panels of about 1,000 watts, mounted on the ladder rack which came on the Ford Econoline van. We used a Renogy Tracer 1000 watt solar controller, an array of 2×200ah lead acid/AGM batteries (inside the van), a marine 24V charger for on-line charging and a Tripp Lite 24V 2000 W inverter. We hooked it up with ancillary 24V DC and 110V AC wiring and hardware, put 2X22CF chest freezers in the van and tweaked it until it worked. It is operationally successful and has never temperature-deviated the contents.

Two problems with the previous prototype suggested the design for the second prototype, Van de Soleil. One problem was inverter loss, measured at 23% of total solar production. The second issue was losses due to heating up inside the van. The standard freezers vented into the van, so ambient heated up during the night cycle when parked. We measured power usage of 2-3 KWh during the 12 hour day cycle when moving along the highway, and 50% more during the 12 hours night cycle. We estimate another 25% energy loss due to this factor, and probably some inefficiencies due to having two duplicate refrigeration units.

Van de Soleil was envisioned to run on 24V DC, to have a split system with venting outside the van, and to have a walk-in freezer. We also planned to enable it to run 24/7 which the previous prototype can't do. The previous prototype has to be plugged in for about 5 to 7 hours at night.

We claim:

1. A freezer vehicle comprising:
at least one solar panel;
at least one battery configured to store energy produced by the solar panel; and
a refrigeration system configured to run on DC energy received from the at least one battery.

2. A freezer vehicle kit comprising:
at least one solar panel to be installed on a vehicle;
at least one battery configured to be installed on a vehicle, the at least one battery electrically connected to the at least one solar panel;
a refrigeration system configured to be installed on a vehicle, the refrigeration system electrically connected to the at least one battery; and
wherein all electrical components of the kit are configured to operate with DC energy.

3. A freezer vehicle comprising:
at least one solar panel;
at least one battery configured to store energy produced by the solar panel;
a refrigeration system electrically connected to the at least one battery; and
wherein the refrigeration system is configured to run 24 hours a day on power produced by the at least one solar panel alone, and the amount of energy used by the refrigeration system is under 20 KW/hrs per 24 hour period.

4. A freezer vehicle comprising all the novel features disclosed herein.

5. A freezer vehicle comprising all the non-obvious features disclosed herein.

6. A freezer vehicle comprising all the novel features and non-obvious features disclosed herein.

7. A freezer vehicle kit comprising all the novel features disclosed herein.

8. A freezer vehicle kit comprising all the non-obvious features disclosed herein.

9. A freezer vehicle kit comprising all the novel features and non-obvious features disclosed herein.
